(19) United States
(12) Patent Application Publication
(10) Pub. No.: US 2005/0212439 A1
(43) Pub. Date: Sep. 29, 2005

(54) Integrating flex circuitry and rigid flexible circuitry, with high power/high brightness LEDs

(75) Inventors: Thomas Lawrence Zampini, Morris, CT (US); Thomas Lawrence Zampini II, Morris, CT (US); Mark Alphonse Zampini, Morris, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Integrated Illumination Systems, Inc., Morris, CT (US)

(21) Appl. No.: 11/087,724

(22) Filed: Mar. 24, 2005

Related U.S. Application Data
(60) Provisional application No. 60/556,055, filed on Mar. 25, 2004.

(51) Int. Cl. G09G 3/32

(52) U.S. Cl. 315/86

(57) ABSTRACT

A flex circuit, rigid-flex circuit at least one high brightness light emitting diode (HBLED) or multiple high brightness light emitting diodes which can be connected either in series or in parallel within the circuit and are soldered to the circuit. The circuit includes one or multiple through hole cut-outs for the LED slug to sit through and attach to a heat sink substrate beneath the LEDs.

### RELATED APPLICATION

The present invention claims priority from Provisional Application No. 60/556,055 filed Mar. 25, 2004, entitled “RIGID-FLEX CIRCUIT” the disclosure of which is hereby incorporated by reference herein in its entirety.

### FIELD OF THE INVENTION

The present invention is related to flexible circuit boards, and more specifically, to flexible circuit boards having one or more high brightness LED's attached to a heat sink.

### BACKGROUND OF THE INVENTION

As LEDs have progressed and have become capable of handling more power than their early predecessor indicator LEDs, one area that becomes critical to the proper operation and longevity of the LED is thermal management. As stated in the document “Thermal Design Using Luxeon Power Light Sources” (Application Brief AB05) by Lumileds LLC, which is hereby incorporated by reference herein in its entirety (hereinafter “Thermal Design”), the manufacturer of the Luxeon High Brightness LED: ”Proper thermal design is imperative to keep the LED emitter package below its rated temperature” (page 1, Thermal Design).

It is well known and a published fact that high brightness and high power LEDs need to be connected to an external heat sink for operation over extended periods of time. As stated by Lumileds LLC in document “Luxeon Reliability” (Application Brief AB25, page 1):
“While the reliability of Luxeon Power Light sources is very high, adherence to the device maximum ratings is required. The overall product reliability depends on the customer's drive conditions and adherence to recommended assembly practices. As with any other type of LED, extreme junction temperatures caused either by excessive power dissipation, an abnormally high thermal path, or improper assembly can cause thermal overstress failures.”

New methods designed to reduce thermal overstress failures of HB LEDs that are available include the utilization of aluminum substrates. Presently in the industry today, the use of Metal Core Printed Circuit Boards (MCPCB) or products based on this technology such as T-Clad™ by Bergquist Company offers a means of extracting the heat from High Brightness LEDs. Essentially, an MCPCB is a PCB (Printed Circuit Board) that utilizes an aluminum or copper plate as a substrate as opposed to FR4, polyimide and other PCB and flexible circuit materials.

The process of installing an LED on an MCPCB is as follows. The LED is glued to the MCPCB via a thermally conductive adhesive. The surface of the LED is glued typically to a copper pad on the dielectric layer or directly to the dielectric layer of the MCPCB. The layers of an MCPCB are configured such that the top layer is copper which is used same as that of a conventional PCB. Beneath the copper is a dielectric layer which isolates the copper from the aluminum or copper substrate beneath it. Once the LED is glued in place, the LED leads are soldered to the MCPCB. In some cases the LED is not glued in place, rather the LED's leads when soldered attach the LED to the MCPCB, or the LED slug is soldered to the MCPCB.

The use of MCPCBs in LED applications is very expensive. Besides the high price, MCPCBs are on a limited basis being offered by only a limited number of manufacturers. The usage of MCPCBs also does not promote the best cooling of the HB LED device. Since in most cases it is required to mount the MCPCB aluminum substrate to an additional heat sink, an additional junction is created (see page 4 of “Thermal Design”), which increases the thermal resistance of the assembly, thus in the long run, potentially the life and performance of the HB LED.

Looking to the future as HB LEDs become more powerful and package size is not drastically increased, the extraction of heat from the HB LED will become more and more critical. As an example, present HB LEDs offer a thermal resistance of approximately 15 degrees Celsius per watt at the area where the die attach combines the die and slug material as seen on page 4 of “Thermal Design”. While a one watt LED sees internally a minor rise in temperature (15° C.) a 5 watt HB LED experiences a 75° C. rise internally (at the junction as described above), therefore leaving very little head room for the remainder of the thermal design as the HB LEDs typically have a maximum junction temperature in the area of 120-130° C. In order to heat sink a device such as a 5 watt HB LED, a minimum amount of thermal junctions will be required in order to assure proper extraction of heat from the HB LED.

Another area where conventional methods of LED installation is limited is the application of installing LEDs around a curved surface. Many applications require such an installation including architectural applications, more specifically edge lighting glass, acrylic, or similar, or applications such as medical applications that require the LEDs to be positioned such that they follow a defined contour. For example, an LED based teeth whitening system would require the LEDs to be positioned such that they follow the shape of the mouth. Traditionally, the process of mounting multiple HB LEDs around a curved surface consists of placing individual Rigid LED PCBs or MCPCBs around the curved surface and then wiring the boards together to form the circuit.

### SUMMARY OF THE INVENTION

The invention is basically a standard flexible circuit which includes an electrical circuit and pads to fit standard surface mount devices (SMD). As defined by IPC-T-50, “Terms and Definitions for Printed Circuit Boards”, a flex circuit is “A patterned arrangement of printed wiring utilizing flexible base material with or without flexible cover layers.” The difference between the present invention and a standard flex circuit lies in the implementation and execution of the HB LEDs.

The answer to the presented problems is to manufacture a flexible circuit that has through holes large enough to fit the thermally conductive bottom/slug of the LED through the hole far enough for the LED to make contact with a heat sink body to which the flexible circuit is mounted. Typically, base material thicknesses of 0.032″ or less is required for this to work effectively.

Flexible circuits are found in nearly every type of electronic product resulting in strong industry knowledge as well as reduced unit cost due to the volume and frequency of production runs. Typically polyimide or polyester is used as a base material, however, following the flex circuit definition, nearly any flexible material may be used.

It is therefore an aspect of the present invention to provide a circuit board assembly including a flexible circuit board that has a hole formed therethrough, at least one high brightness light emitting diode, an external heat sink operatively connected to the at least one high brightness light emitting diode wherein the hole through the flexible circuit board permits the high brightness light emitting diode to extend through and contact the external heatsink.

The foregoing and other aspects of the present invention are achieved by a lighting assembly including a flexible circuit board having at least one hole formed there through, at least one high brightness light emitting diode, an external heat sink operatively connected to the at least one high brightness light emitting diode, wherein the at least one hole through the flexible circuit board permits the high brightness light emitting diode to extend through and contact the external heat sink, and wherein a body has a curved surface wherein the flexible circuit board is bent to conform to the curved surface.

Still other aspects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and several details are capable of modification in various obvious respects, all without departing from the invention. Accordingly, the drawings are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a perspective view of the flexible circuit board assembly attached to a body;

FIG. 2 is a top plan view of the flexible circuit board of FIG. 1; and

FIG. 3 is a perspective view of the flexible circuit board assembly with heat sink rods attached to LEDs with the body partially omitted.

### BRIEF DESCRIPTION OF THE INVENTION

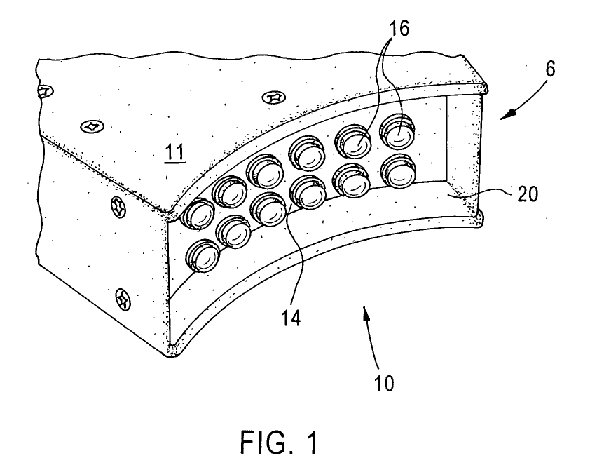

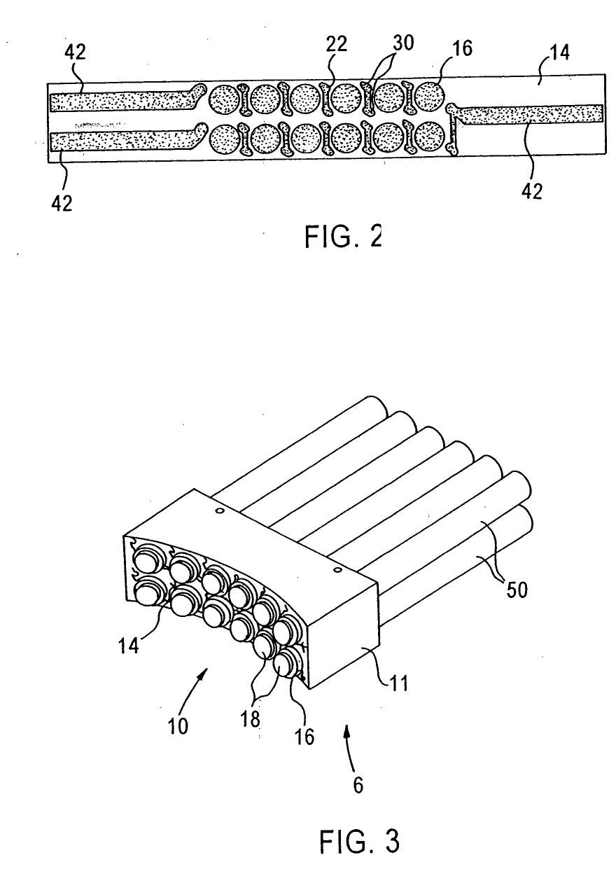

Referring first to FIG. 1, there is shown an illustrative flexible lighting assembly 6 including flexible circuit board assembly 10 according to the present invention mounted to a body 11. The assembly 10 includes a flexible rectangular circuit board 14 including a plurality of through holes 16 into which a corresponding plurality of high brightness LEDs 18 are placed. As illustrated in FIG. 2, the circuit board 14 includes traces 22. As illustrated in FIG. 2, each through hole 16 has respective pads 30. As illustrated in FIG. 1, the body 12 has a curved surface 20 to which the flexible circuit board 14 is mounted in a conventional manner. The LEDs 18 are glued to the body 11. The flexible circuit board 14 is adhered to the body 11.

The HB LEDs 18 are connected to the flexible circuit board 14 in series, parallel or series-parallel combinations by means of solder, electrically conductive epoxy or any other means electrically connecting a device.

It is a well-known and published fact that high brightness and high-power LEDs need to be connected to an external heat sink for operation over extended periods of time. As used herein, the term “HB LED” means LEDs of all types, light emitting polymers, and semiconductor dies that produce light in response to current that needs to be connected to a heat sink for optimal operation. Additional benefits of utilizing a heat sink include: operation in higher ambient temperatures and promotion of an extended life of the HB LED.

As illustrated in FIG. 1, the LEDs 18 extend through the holes 16 in the flexible circuit board 14. The holes 16 are larger than the outside diameter of the LEDs 18.

Traces (wires not shown) are shown in FIG. 2. U.S. application Ser. No. 10/941,081 entitled “VERSATILE THERMALLY ADVANCED LED FIXTURE” filed on Sep. 15, 2004, is hereby incorporated by reference in its entirety.

As illustrated in FIG. 1, the flexible circuit board 14 can advantageously be fit to a curved surface 20 as illustrated in FIG. 1. Advantageously the flexible circuit board 14 can mount the HB LEDs 18 to a surface having a radius or circumference.

Also, the flexible circuit board 14 can be adhered to the curved surface 20 during assembly by applying an adhesive strip 42 (not shown). The adhesive strip is mounted on the entire back side of the flexible circuit board 14 during the fabrication of the flex circuit board 14. An adhesive strip aids in assembly processes a well as the overall integrity of the system.

Refer now to FIG. 3. FIG. 3 is a perspective view of the flexible lighting assembly 6 with a portion of the body 11 omitted for clarity to show the heat sink rods 50. The heat sink rods 50 can be any type of high conductive rate material including, for example, aluminum and copper. The body 11 could be either a metal or plastic. If the body 11 is metal, then the heat sink rods 50 could be attached to further effect heat transfer from the LEDs 18.

Other flexible circuit configurations also offer a major weight reduction when compared to MCPCB or fiberglass based PCB technology as in extreme cases, a flexible circuit board can be manufactured down to less than a 50 μm total thickness.

The present invention may utilize any form and configuration of flexible circuits including:
single-sided flex circuits, which are the most common and have a single patterned conductor layer; double access flex circuits, which are similarly a single conductor layer, however allow access from both sides of the base material; double sided flex circuits, which have two conductive layers; and multilayer flex circuits, which have three or more conductive layers; rigid-flex circuits, which are a hybrid construction having rigid and flexible substrates laminated together.
   Through the use of flexible circuits, the overall thermal model of the LED system is enhanced through the elimination of a potential junction (the MCPCB). The bottom (slug) or other heat transferring section of the HB LED fits through a through the hole 16 in the flexible circuit and is fastened to an external heat sink 50, with a thermally conductive material, including but not limited to an electrically neutral thermal grease, an electrically neutral thermal pad, or an electrically neutral, thermally conductive epoxy. As the HB LED slugs are typically not electrically neutral, as opposed to sharing a single heat sink, when more than one HB LEDs are utilized, each HB LED may have its own isolated heat sink. (see U.S. patent application Ser. No. 10/941,081, “Versatile Thermally Advanced LED Fixture”).

When integrating HB LEDs, in some cases it is desirable to position the LEDs around a curved surface. An added advantage of the flexible circuit is that the HB LEDs can be mounted to a curved surface while utilizing a single circuit board. This is not possible to do with an MCPCB or any available methods to date. With the flex circuit, the LEDs are soldered to the flex circuit, the LED base is thermally connected to the heat sink (the curved surface), and the traces that form the electrical circuit are part of the one or multiple conductor layers of the flex circuit, which follows the contour of the curved surface. This is advantageous for volume production as the number of interconnects is reduced, thus the manufacturing process is less labor intensive. This is also advantageous in regard to reliability as typically failures in electronic systems are at a point of intersection, thus with a reduced number of intersections, the flex circuit configuration is favorable in terms of reliability. The HB LEDs are connected to the flexible circuit in series, parallel or series-parallel combinations by means of solder, electrically conductive epoxy or any other means of electrically connecting a device.

In some cases, it is required that the LED assembly is configured such that the flex circuit will adhere to the surface it is mounted to. This requirement stems from several possibilities including (a) manufacturing process where it is required to adhere the flex circuit prior to installing LEDs to insure proper alignment and (b) where it is required that the flex circuit be mounted to the surface it is installed to. In order to fulfill this requirement, the base material of the present invention may be configured such that it is manufactured with an adhesive front and back, front, or back. The adhesive sections may be selective areas of the flex circuit. Another means of fulfilling this requirement is positioning through holes in the flex circuit such that screws or other fasteners may fasten it down to the surface.

The flexible circuit receives voltage and current to power the HB LEDs and any other components on the board through direct solder of wires to the flexible circuit or through any type of interconnect. Flex circuits may also be terminated with a variety of connector solutions that terminate directly to the base material, thus eliminating the use of wire between the flex circuit and other electronic assemblies. In some cases it is desirable to include additional electronic components physically located on the same flex circuit as the HB LEDs. The versatility of the flex circuit allows this configuration. Therefore the circuitry that controls and illuminates the LEDs may be located remotely or locally to the HB LEDs. U.S. Provisional Application No. 60/560,294 “SMART DRIVER” filed Apr. 8, 2004, is hereby incorporated by reference herein in its entirety.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A circuit board assembly, comprising:
a flexible circuit board having at least one hole formed therethrough,
at least one high brightness light emitting diode;
an external heat sink operatively connected to said at least one high brightness light emitting diode;
wherein said at least one hole through said flexible circuit board permits said high brightness light emitting diode to extend through and contact the said external heatsink.

2. The circuit board assembly of claim 1, wherein said flexible circuit board has single or multiple layers of circuitry.

3. The circuit board assembly of claim 1, wherein said at least one high brightness LED is powered by direct soldering of wires or through interconnects.

4. The circuit board assembly of claim 1, wherein the main function of the circuit board assembly is to emit light.

5. The circuit board assembly of claim 1, wherein a lighting function is provided by light emitting diodes.

6. The circuit board assembly of claim 1, further comprising a device for regulating the current or voltage available to the LED or LEDs.

7. The circuit board assembly of claim 1, wherein said heat sink is attached to said LED by a thermal grease, a thermal pad, or a, thermally conductive epoxy.

8. The circuit board assembly of claim 1, wherein said HB LEDs are connected to the flexible circuit in series, parallel or series-parallel combinations by solder or electrically conductive epoxy.

9. The circuit board assembly of claim 1, wherein said HB LEDs are connected to the flexible circuit board in series, parallel or series-parallel combinations by any means of electrically connecting a device.

10. The circuit board assembly of claim 1, wherein said flexible circuit board can be fastened around a curved surface.

11. The circuit board assembly of claim 1, wherein said LEDs can be mounted to a curved surface of said flexible circuit board.

12. The circuit board assembly of claim 1, wherein additional control components are installed to the flexible circuit.

13. The circuit board assembly of claim 1, wherein said flexible circuit board is single-sided.

14. The circuit board assembly of claim 1, wherein said flexible circuit is double-sided.

15. The circuit board assembly of claim 1, wherein said flexible circuit is a double access flex circuit.

16. The circuit board assembly of claim 1, wherein said flexible circuit is a multilayer flex circuit.

17. The circuit board assembly of claim 1, wherein said flexible circuit is a hybrid construction having rigid and flexible substrates laminated together.

18. The circuit board assembly of claim 1, further comprising a body having a curved surface wherein said flexible circuit board is bent to conform to said curved surface.

19. The circuit board assembly of claim 18, further comprising means to mount said flexible circuit board to said curved surface of said body.

20. The circuit board assembly of claim 1, wherein said through holes in said flexible circuit board have a larger diameter than an outer diameter of said LEDs.

21. The circuit board assembly of claim 1, wherein said flexible circuit board has a thickness of 0.032″ or less.

22. A lighting assembly, comprising:
a flexible circuit board having at least one hole formed there through,
at least one high brightness light emitting diode;
an external heat sink operatively connected to said at least one high brightness light emitting diode;
wherein said at least one hole through said flexible circuit board permits said high brightness light emitting diode to extend through and contact the said external heat sink,
wherein a body having a curved surface wherein said flexible circuit board is bent to conform to said curved surface.

23. The circuit board assembly of claim 22, wherein said flexible circuit board has single or multiple layers of circuitry.

24. The circuit board assembly of claim 22, wherein said at least one high brightness LED is powered by direct soldering of wires or through interconnects.

25. The circuit board assembly of claim 22, wherein the main function of the circuit board assembly is to emit light.

26. The circuit board assembly of claim 22, wherein a lighting function is provided by light emitting diodes.

27. The circuit board assembly of claim 22, further comprising a device for regulating the current or voltage available to the LED or LEDs.

28. The circuit board assembly of claim 22, wherein said heat sink is attached to said LED by a thermal grease, a thermal pad, or a, thermally conductive epoxy.

29. The circuit board assembly of claim 22, wherein said HB LEDs are connected to the flexible circuit in series, parallel or series-parallel combinations by solder or electrically conductive epoxy.

30. The circuit board assembly of claim 22, wherein said HB LEDs are connected to the flexible circuit board in series, parallel or series-parallel combinations by any means of electrically connecting a device.

31. The circuit board assembly of claim 22, wherein said flexible circuit board can be fastened around a curved surface.

32. The circuit board assembly of claim 22, wherein said LEDs can be mounted to a curved surface of said flexible circuit board.

32. The circuit board assembly of claim 22, wherein additional control components are installed to the flexible circuit.

33. The circuit board assembly of claim 22, wherein said flexible circuit board is single-sided.

34. The circuit board assembly of claim 22, wherein said flexible circuit is double-sided.

35. The circuit board assembly of claim 22, wherein said flexible circuit is a double access flex circuit.

36. The circuit board assembly of claim 22, wherein said flexible circuit is a multilayer flex circuit.

37. The circuit board assembly of claim 22, wherein said flexible circuit is a hybrid construction having rigid and flexible substrates laminated together.

38. The circuit board assembly of claim 22, further comprising means to mount said flexible surface board to said curved surface of said body.

39. The circuit board assembly of claim 22, wherein said through holes in said flexible surface board have a larger diameter than an outer diameter of said LEDs.

40. The circuit board assembly of claim 22, wherein said flexible surface board has a thickness of 0.032″ or less.
